(19) United States
(12) Patent Application Publication
(10) Pub. No.: US 2026/0287013 A1
(43) Pub. Date: Sep. 24, 2026

(54) ROLLING BEARING AND METHOD FOR REMANUFACTURING A ROLLING BEARING

(71) Applicant: AKTIEBOLAGET SKF, GOTEBORG (SE)

(72) Inventors: Daniel CAPOLDI, Avallon (FR); David RAGOT, Courcelles de Touraine (FR); Benoit MARS, Notre Dame d'Oé (FR)

(21) Appl. No.: 19/565,813

(22) Filed: Mar. 13, 2026

(30) Foreign Application Priority Data
Mar. 21, 2025 (DE) 102025110947.8

(51) Int. Cl. F16C 19/38; F16C 35/04

(52) U.S. Cl. CPC F16C 19/381; F16C 35/045

(57) ABSTRACT

A rolling bearing includes a first ring having a radial raceway and a concentric second ring, the second ring being formed from first and second axially connected ring parts, and a row of radial rolling elements between the radial raceway of the first ring and a radial raceway of the second ring part. The first ring part includes an axially projecting circumferential flange, and the second ring part includes an annular protrusion axially delimiting the radial raceway of the second ring part that protrudes radially toward the first ring. A circumferential surface of the flange is in contact with a circumferential surface of with the protrusion, the flange includes an axial slot open toward the first ring, and the slot is dimensioned such that each radial rolling element can pass axially through the slot.

### CROSS-REFERENCE

This application claims priority to German patent application no. 10 2025 110 947.8 filed on Mar. 21, 2025, the contents of which are fully incorporated herein by reference.

### TECHNOLOGICAL FIELD

The present disclosure relates to the field of rolling bearings. In particular, the disclosure is directed to the field of large-diameter rolling bearings that can accommodate axial and radial loads. Such large-diameter rolling bearings may be used for example in a tunnel boring machine, in a mining extraction machine or in a wind turbine.

### BACKGROUND

A large-diameter rolling bearing has a first ring, for instance an inner ring, and a second ring, for instance an outer ring, capable of rotating concentrically relative to one another. To accommodate the radial loads, at least one row of radial rolling elements is radially interposed between respective raceways of the first ring and the second ring.

To allow the rolling elements to be placed or removed from between the raceways, the second ring is split into a first part ring and a second part ring stacked one relative to the other in the axial direction, the first part ring being removable to give access to the rolling elements. The second part ring is provided with the second raceway, and the first part ring comprises a nose axially facing the radial rolling elements. When the first part ring and the second part ring are stacked, the nose of the first part ring is engaged with a portion of the second part ring to radially immobilize the first part ring with respect to the second part ring. This cooperation of the nose and the second part ring is a constraint when designing the rolling bearing.

### SUMMARY

One aspect of the present disclosure is to overcome this drawback.

The disclosure relates to a rolling bearing comprising a first ring and a second ring configured to rotate concentrically relative to one another about an axially extending axis of rotation and at least one row of radial rolling elements radially interposed between first and second raceways of the rings. The second ring is split into a first part ring and a second part ring stacked one relative to the other in the axial direction, the second part ring has the second raceway and the first part ring comprises a nose axially facing the radial rolling elements.

The second part ring of the second ring comprises an annular protrusion axially delimiting the second raceway and protruding radially relative to the second raceway, the nose of the first part ring being engaged with the protrusion. In addition, at least one slot is formed on a surface of the protrusion radially facing the first ring, the slot being dimensioned such that each radial rolling element can be introduced between walls of the slot and the first raceway of the first ring.

In practice, when assembling the rolling bearing, the first ring and the second part ring are first assembled and the rolling elements are then placed between the facing raceways by being approached according to the axial direction. Since the annular protrusion protrudes radially relative to the second raceway, it forms an obstacle between the rolling elements and the space between the raceways. However, the slot forms a local clearance for the rollers through the annular protrusion, allowing the rolling elements to be placed between the raceways.

The slot does not affect its cooperation with the nose of the first part ring to radially immobilize the first part ring with respect to the second part ring. The rolling bearing may thus be designed with a variety of desired diameters for the rolling elements without modifying the design of the nose of the first part ring. The design of the rolling bearing is thus simplified.

According to another aspect, the radial distance between a bottom wall of the slot and the first raceway of the first ring is at least equal to the diameter of the radial rolling elements, and the circumferential distance between opposite lateral walls of the slot is at least equal to the diameter of each radial rolling element.

According to another aspect, the circumferential distance between the opposite lateral walls of the slot is about two times the diameter of each radial rolling elements.

According to another aspect, the walls of the slot include a bottom wall extending circumferentially and two circumferentially opposite lateral walls each extending radially from a corresponding end of the bottom wall, the bottom wall having a shape matching the shape of the second raceway.

According to another aspect, at least one row of axial rolling elements is axially interposed between raceways of the first part ring and the first ring, and/or between raceways of the second part ring and the first ring, the axial rolling elements being configured to form an axial thrust, the radial rolling elements being configured to form a radial thrust.

According to another feature, one of the first ring and second ring is an inner ring and the other of the first ring and second ring is an outer ring surrounding the inner ring.

The present disclosure further relates to a method for remanufacturing a rolling bearing as described above from an initial rolling bearing.

The method comprises the steps of: 1) providing an initial rolling bearing comprising a first ring and a second ring configured to rotate concentrically relative to one another about an axially extending axis of rotation, at least one row of radial rolling elements radially interposed between first and second raceways of the rings, the second ring being split into a first part ring and a second part ring stacked one relative to the other in the axial direction, the second part ring being provided with the second raceway and the first part ring comprising a nose axially facing the radial rolling elements; 2) separating the second part ring of the second ring from the first part ring and removing the row of radial rolling elements, 3) machining the second part ring to (i) remove an annular layer of material from the second raceway, thereby forming an annular protrusion axially delimiting the second raceway and protruding radially relative to the second raceway, the nose of the first part ring being engaged with the protrusion when the rolling bearing is assembled, and to (ii) form at least one slot on a surface of the protrusion configured to radially face the first ring, the slot being dimensioned such that each radial rolling element can be introduced between walls of the slot and the first raceway of the first ring when the rolling bearing is assembled; 4) assembling the second part ring of the second ring with the first ring, and mounting a new row of rolling elements radially between the first and second raceways of the first and second rings, each of a diameter equal to the sum of the diameter of the previous rolling elements and the radial thickness of the removed layer of material; and 5) assembling the first part ring of the second ring with the second part ring of the second ring.

According to another aspect, the second raceway in the initial rolling bearing and the surface of the protrusion in which is formed the slot in the remanufactured rolling bearing have the same diameter. According to another aspect, the initial rolling bearing is a previously used rolling bearing and the removed layer of material includes degraded material.

### BRIEF DESCRIPTION OF THE DRAWINGS

Other advantages and features of the disclosure will appear on examination of the detailed description of embodiments, in no way restrictive, and the appended drawings in which:

FIG. 1 is a schematic cross-section and partially exploded view of a rolling bearing having concentric inner and outer rings according to an aspect of the present disclosure.

FIG. 2 is a detail view of a portion of FIG. 1 in which the rolling bearing is assembled.

FIG. 3 shows two radially opposite portions of the rolling bearing as seen from the top of FIG. 1, a first part ring of the inner ring omitted for illustration purposes.

FIG. 4 is a cross-section view of an initial rolling bearing from which the rolling bearing of FIGS. 1 to 3 was obtained by the method according to the disclosure.

FIG. 5 illustrates steps of the method for remanufacturing the rolling bearing of FIGS. 1 to 3 from the initial rolling bearing of FIG. 4.

### DETAILED DESCRIPTION

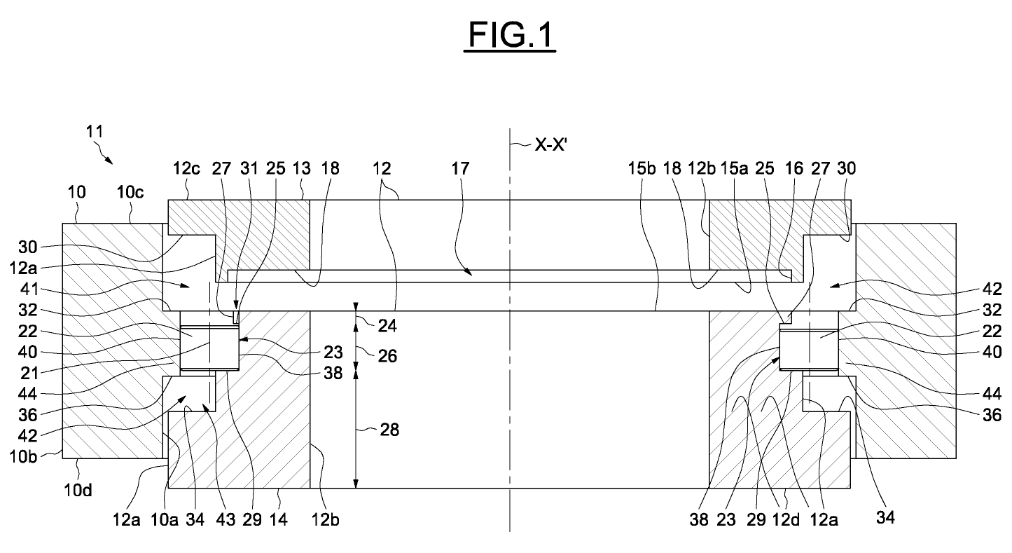

The rolling bearing 11 illustrated in FIGS. 1 to 3 is a large-diameter rolling bearing comprising a first ring 10 and a second ring 12. In the illustrated example, the first ring 10 is an outer ring and the second ring 12 is an inner ring surrounded by the outer ring. The rolling bearing 11 may for example be used in a machine, such as tunnel boring machine, a wind turbine or any other machines using a large diameter rolling bearing.

The outer and inner rings 10, 12 are capable of rotating concentrically relative to one another. The outer and inner rings 10, 12 are arranged concentrically about the rolling bearing rotation axis X-X’ which runs in an axial direction. The outer and inner rings 10, 12 each extend axially along the axis X-X’. In this illustrated example, the outer and inner rings 10, 12 are of the solid type.

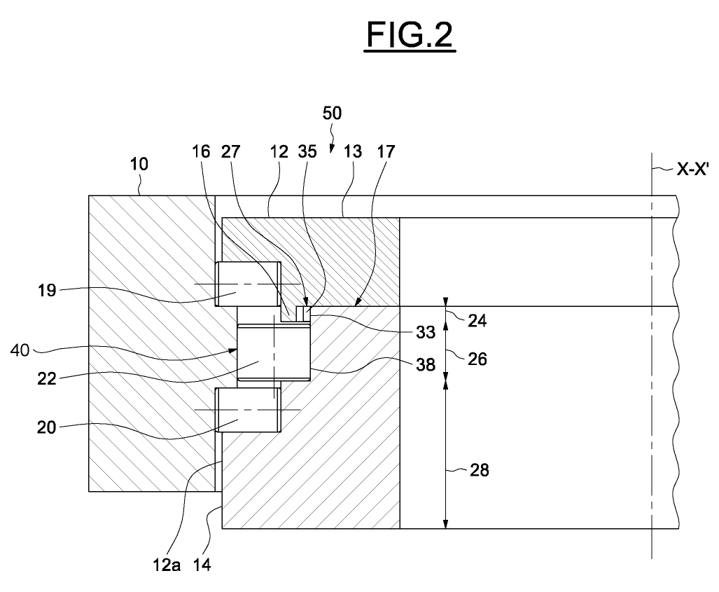

The inner ring 12 is formed as a split ring and comprises a first part ring 13 and a second part ring 14 stacked one relative to the other in the axial direction. The first and second part rings 13, 14 are shown at a distance from each other in FIG. 1 and shown assembled in FIG. 2. In the following the rolling bearing 11 is described as if the part rings 13, 14 were assembled, as in FIG. 2.

The first and second part rings 13, 14 are provided with a plurality of aligned axial through-holes (not illustrated) in order to be joined together and to assemble the inner ring 12 to a first part of a structure of the associated machine by bolts.

The outer ring 10 is also provided with a plurality of axial through-holes (not illustrated) to assemble the outer ring 10 to a second part of the associated machine by bolts. The first and second parts of the machine are axially disposed on each side of the rolling bearing 11.

The rolling bearing 11 comprises rolling elements, here rollers 19, 20, 22. In the illustrated example, the rolling bearing 11 comprises two rows of axial rollers 19, 20 and a single row of radial rollers 22. In a non-illustrated variant, the rolling bearing comprises only one row of axial rollers or more than two rows of axial rollers.

The axial rollers 19, 20 are arranged between the outer and inner rings 10, 12 to form an axial thrust bearing. The outer and inner rings 10, 12 delimit together a first axial housing 41 and a second axial housing 43 configured to receive the row of axial rollers 19 and 20 respectively.

The radial rollers 22 are arranged between the outer and inner rings 10 and 12 to form a radial thrust. The outer and inner rings 10, 12 delimit together a radial housing 23 configured to receive the row of radial rollers 22. The radial housing 23 is axially located between the first axial housing 41 and the second axial housing 43.

The rollers 19, 20, 22 are cylindrical. The rollers 19, 20, 22 of one and the same row are identical to one another and each of the same respective predetermined diameter. The axis of rotation 21 of each roller 22 is parallel to the axis X-X’ of the rolling bearing 11 and perpendicular to the axis of rotation of each of the rollers 19, 20.

The axial rollers 19 are axially interposed between annular radial raceways 30, 32 respectively formed on the inner and outer rings 12, 10. The raceways 30, 32 face each other in the axial direction. The rolling surface of each axial roller 19 is in axial contact with the raceways 30, 32. The axial rollers 20 are axially interposed between annular radial raceways 34, 36 respectively formed on the inner and outer rings 12, 10. The raceways 34, 36 axially face each other. The rolling surface of each axial roller 20 is in axial contact with the raceways 34, 36. The rows of axial rollers 19, 20 are spaced apart from each other in the axial direction.

The radial rollers 22 are radially interposed between first and second annular axial raceways 40, 38 respectively formed on the outer and inner rings 10, 12. The raceways 38, 40 extend according to axis X-X’. The raceways 38, 40 face each other in the radial direction. The row of radial rollers 22 is radially offset inwards with respect to the rows of axial rollers 19, 20. The rolling surface of each radial roller 22 is in radial contact with the raceways 38, 40. The row of radial rollers 22 is axially located between the rows of axial rollers 19, 20.

The outer ring 10 comprises an annular protruding nose 44 engaging into an annular groove 42 of the inner ring 12. The nose 44 extends radially inwards. The annular groove 42 opens in a radial direction outwardly towards the outer ring 10. The outer ring 10 comprises an inner stepped cylindrical bore surface 10a and an outer cylindrical surface 10b which is radially opposite to the inner surface 10a. The outer ring 10 further comprises two opposite radial frontal surfaces 10c, 10d which axially delimit the inner surface 10a and the outer surface 10b. The frontal surfaces 10c, 10d axially delimit the outer ring 10. The frontal surfaces 10c, 10d axially delimit the thickness of the outer ring 10. The protruding nose 44 is delimited by the inner surface 10a. In the illustrated example, the outer ring 10 is made in one part.

The inner ring 12 comprises an outer stepped cylindrical surface 12a delimiting the groove 42. The inner ring 12 further comprises an inner cylindrical bore surface 12b which is radially opposite to the outer surface 12a. The inner ring 12 further comprises two axially opposite radial frontal surfaces 12c, 12d which axially delimit the outer surface 12a and the inner surface 12b. The frontal surfaces 12c, 12d axially delimit the inner ring 12. The frontal surfaces 12c, 12d axially delimit the thickness of the inner ring 12.

The rows of axial rollers 19, 20 are arranged in the groove 42, axially between the nose 44 of the outer ring 10 and the outer surface 12a of the inner ring 12. The rows of axial rollers 19, 20 are disposed axially on either side of the nose 44 respectively. The radial raceways 32, 36 are located on the nose 44. The radial raceways 32, 36 are disposed axially on either side of the nose 44 respectively. The radial raceways 30, 34 are located on outer surface 12a.

The row of radial rollers 22 is arranged in the groove 42, radially between the nose 44 of the outer ring 10 and the outer surface 12a of the inner ring 12. The axial raceways 40 and 38 are respectively located on the nose 44 and the outer surface 12a.

As previously mentioned, the inner ring 12 is divided in the axial direction in two separate parts, namely the first part ring 13 and the second part ring 14. The part rings 13, 14 delimit together the groove 42. The raceway 30 is located on the first part ring 13 and the raceway 34 is located on the second part ring 14. The frontal surface 12c is located on the first part ring 13 and the frontal surface 12d is located on the second part ring 14.

The first part ring 13 delimits with the outer ring 10 the first axial housing 41, while the second part ring 14 delimits with the outer ring 10 both the second axial housing 43 and the radial housing 23. The first part ring 13 comprises an intermediate frontal surface 15a which is axially opposite to the frontal surface 12c and which axially delimits the portions of the outer surface 12a and inner surface 12b belonging to the first part ring 13. The intermediate frontal surface 15a and the frontal surface 12c axially delimit the first part ring 13.

The first part ring 13 comprises an axial annular flange 16 which extends axially from the intermediate frontal surface 15a up to a shoulder 18 of the inner surface 12b. The annular flange 16 is cylindrical. The annular flange 16, or more specifically the portion of the inner surface 12b that forms a side of the annular flange 16, delimits with the shoulder 18 an annular coupling recess 17. The annular flange 16, or more specifically the portion of the intermediate frontal surface 15a that forms part of the annular flange 16, delimits partially the radial housing 23 and thus axially faces the radial rollers 22 received therein.

The second part ring 14 comprises an intermediate frontal surface 15b which is axially opposite to the frontal surface 12d and which axially delimits the portions of the outer surface 12a and inner surface 12b belonging to the second part ring 14. The intermediate frontal surface 15b and the frontal surface 12d axially delimit the second part ring 14. The second part ring 14 comprises a coupling portion 24 which extends axially from the intermediate frontal surface 15b, and a raceway portion 26 which extends axially from the coupling portion 24 towards the frontal surface 12d, in other words from the coupling portion 24 away from the first part ring 13. The second part ring 14 further comprises a base portion 28 which extends axially from the raceway portion 26 to the frontal surface 12d.

The coupling portion 24 and the raceway portion 26 are both cylindrical. The base portion 28 includes two successive cylindrical segments of increasing outer diameters in the direction of the frontal surface 12d.

The diameter of the outer surface 12a changes between the coupling portion 24 and the raceway portion 26, the outer surface 12a thereby having a shoulder 25 at the junction between the coupling and raceway portions 24, 26. The change in diameter is so that the shoulder 25 faces towards the raceway portion 26. In the illustrated example, the diameter of the outer surface 12a in the raceway portion 26 is smaller than its diameter in the coupling portion 24.

The shoulder 25, the portion of the outer surface 12a that connects the shoulder 25 to the intermediate frontal surface 15b and the portion of the intermediate frontal surface 15b that axially faces the shoulder 25 together delimit a radial annular protrusion 27 in the coupling portion 24. The protrusion 27 extends radially beyond the raceway portion 26 on the same side as the outer surface 12a, that is to say towards the outer ring 10. In other words, the protrusion 27 protrudes radially relative to the second raceway 38 which is part of the raceway portion 26.

The diameter of the outer surface 12a changes between the raceway portion 26 and the base portion 28, the outer surface 12a thereby having a shoulder 29 at the junction between the raceway and base portions 26, 28. The change in diameter is so that the shoulder 29 faces towards the raceway portion 26. In the illustrated example, the diameter of the outer surface 12a in the raceway portion 26 is smaller than its diameter in the base portion 28. The shoulder 29 and the shoulder 25 are arranged opposite one to the other.

The protrusion 27, or more specifically the shoulder 25 of the protrusion 27, delimits a portion of the radial housing 23. The protrusion 27, or more specifically the shoulder 25, further delimits the axial raceway 38. The raceway portion 26, or more specifically the portion of the outer surface 12a that belongs to the raceway portion 26, radially delimits the radial housing 23 and forms the axial raceway 38. The base portion 28, or more specifically the shoulder 29 of the base portion 28, partially delimits the radial housing 23.

The coupling portion 24 of the second part ring 14 and the coupling recess 17 of the first part ring 13 are configured to fit one into the other to radially immobilize the first and second part rings 13, 14 one with respect to the other. More specifically, when the coupling portion 24 is received in the coupling recess 17, that is to say when the flange 16 is engaged with the protrusion 27 of the coupling portion 24, the portion of the outer surface 12a belonging to the coupling portion 24 is in contact with the portion of the inner surface 12b that forms part of the axial annular flange 16, the surface portions having corresponding respective diameters.

The coupling portion 24 further comprises a slot 31 formed on a surface of the radial annular protrusion 27 radially facing the first ring 10. More specifically, the slot 31 is formed on the portion of the outer surface 12a that connects the shoulder 25 to the intermediate frontal surface 15b. The slot 31 opens through both the shoulder 25 and the intermediate frontal surface 15b. The slot 31 comprises a bottom wall 33 extending circumferentially and two circumferentially opposite lateral walls 35 each extending radially from a corresponding end of the bottom wall 33. The bottom wall 33 here has a shape matching the shape of the raceway 38. The lateral walls 35 here each have a curved shape and are symmetrical one with respect to the other.

As explained in further details below, the slot 31 is dimensioned such that each radial roller 22 can be introduced between the walls 33, 35 of the slot 31 and the first raceway 40 of the first ring 10.

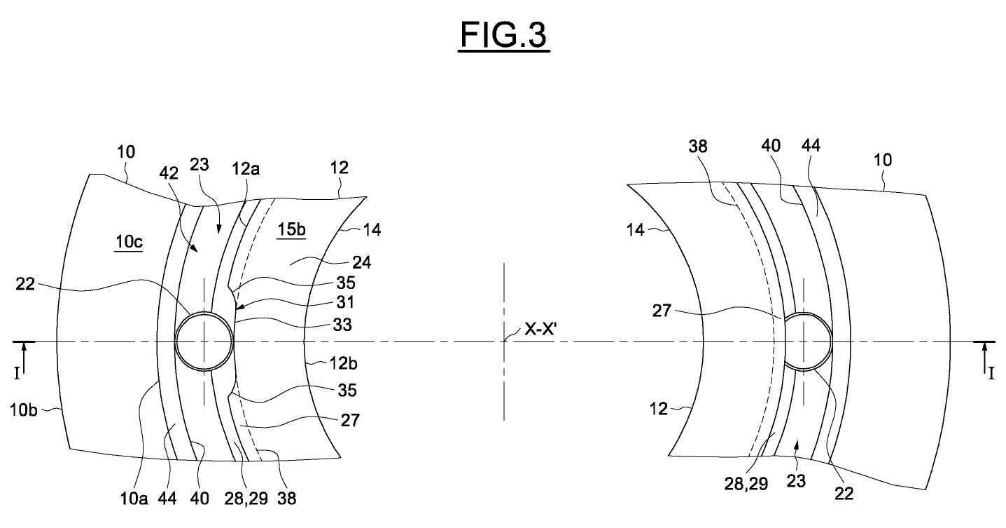

Accordingly, as can be seen in FIGS. 1 and 3, even when the first part ring 13 is removed from the rolling bearing 11, a radial roller 22 received in the radial housing 23 is blocked by the radial annular protrusion 27 according to the axial direction, except when it is in line with the slot 31. In other words, the slot 31 locally forms a clearance for the rollers 22 through the annular protrusion 27.

When the first part ring 13 is separated from the second part ring 14, the rollers 22 can thus be removed from the housing 23 through the slot 31. Of course, it is the same if a roller 22 is outside the radial housing 23 and is to be introduced in the radial housing 23. Preferentially, the radial distance between the bottom wall 33 of the slot 31 and the raceway 40 of the outer ring 10 is at least equal to the diameter of the radial rollers 22. In addition, the circumferential distance between the opposite lateral walls 35 of the slot 31 may be at least equal to the diameter of each radial roller 22. In the illustrated example, this circumferential distance is about two times the diameter of a roller 22.

To be noted that depending on the radial thickness of the protrusion 27, the above circumferential distances may be greater than what would be strictly necessary to pass the roller 22 through the slot 31. However, such circumferential distances allow a gap to remain between the roller 22 and the lateral walls 35 of the slot 31 thereby facilitating the handling of the roller 22, for instance by passing a tool through the gap.

More generally, the slot 31 may be dimensioned such that at least the portion of a radial roller 22 that is axially in line with the protrusion 27 can pass through the slot 31 when displaced according to the axial direction. In any case, the slot 31 is dimensioned so as not to compromise the immobilizing function of the coupling portion 24 and the flange 16. In particular, the circumferential distance between the opposite lateral walls 35 of the slot 31 is less than half the perimeter of the coupling portion 24.

In a non-illustrated variant, the rollers are another type of rolling elements, for instance spherical balls.

In a non-illustrated variant, the coupling portion 24 is provided with a plurality of slots such as slot 31, for instance regularly distributed along the circumference of the coupling portion 24.

In a non-illustrated variant, the first ring, such as ring 10, is configured to be an inner ring while the second ring, such as ring 12, is configured to be an outer ring surrounding the inner ring, and the above description applies mutatis mutandis. For instance, in such a variant, for the change in diameter between the coupling portion 24 and the raceway portion 26 to be so that the shoulder 25 faces towards the raceway portion 26, the diameter of the outer surface 12a in the raceway portion 26 would have to be bigger than its diameter in the coupling portion 24. In addition, for the change in diameter between the raceway portion 26 and the base portion 28 to be so that the shoulder 29 faces towards the raceway portion 26, the diameter of the outer surface 12a in the raceway portion 26 would have to be bigger than its diameter in the base portion 28. In such a variant, the surfaces 10a, 12a would face inwardly, while the surfaces 10b, 12b would face outwardly.

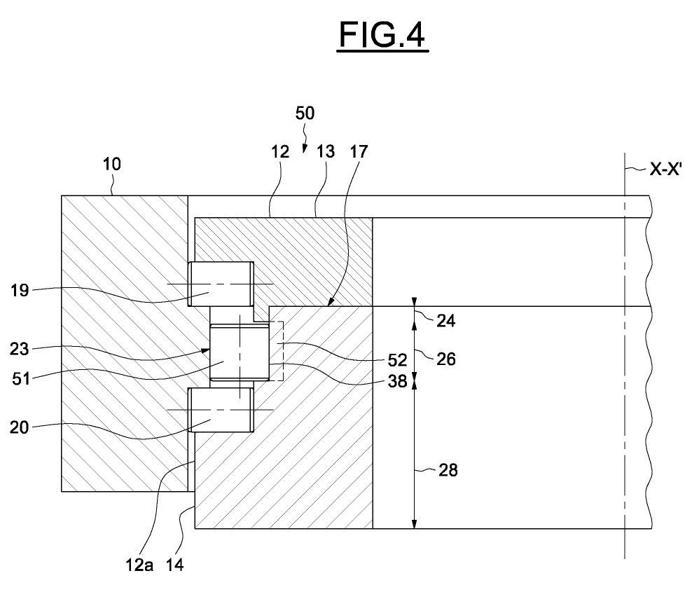

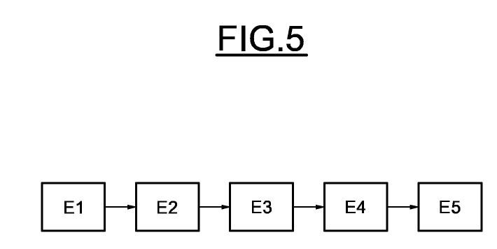

With reference to FIGS. 4 and 5, it will now be described an initial rolling bearing 50 from which the rolling bearing 11 has been obtained by remanufacturing, and a method carried out to remanufacture the rolling bearing 11 from the initial rolling bearing 50.

The initial rolling bearing 50 illustrated in FIG. 4 is identical to the remanufactured rolling bearing 11 except that the raceway portion 26 includes an additional annular layer of material 52, that the slot 31 is not present in the coupling portion 24, and that the row of rollers 22 are replaced by a row of initial radial rollers 51 of a smaller diameter. More specifically, the diameter of rollers 22 is the sum of the diameter of initial, or previous, rollers 51 and the thickness of the layer 52.

The layer of material 52 is on the side of the raceway portion 26 facing the first ring 10. The layer of material 52 is cylindrical. The layer of material 52 has a predetermined constant thickness. The layer of material 52 extends axially from the coupling portion 24 to the base portion 28. In the illustrated example, the thickness of layer 52 is such that the diameters of the outer surface 12a are the same in the coupling portion 24 and in the raceway portion 26. In other words, the second raceway 38 in the initial rolling bearing 50 has the same diameter as the surface of the protrusion 27 in which is formed the slot 31 in the rolling bearing 11.

Accordingly, the initial rolling bearing 50 does not have a radial annular protrusion 27. In addition, the raceway 38 is radially closer to the raceway 40 than it is in the rolling bearing 11, the radial housing 23 being thus smaller than it is in the rolling bearing 11.

The radial housing 23 of the initial rolling bearing 50 is configured to receive the row of initial radial rollers 51 that are each of the same initial predetermined diameter.

The method includes a step E1 of providing the initial rolling bearing 50. The method further includes a step E2 of separating the second part ring 14 of the second ring 12 from the first part ring 13 and removing the row of radial rollers 51. The method further includes a step E3 of machining the second part ring 14 to (i) remove the annular layer of material 52 from the second raceway 38, thereby forming the annular protrusion 27, and to (ii) form the slot 31. The method further includes a step E4 of assembling the second part ring 14 of the second ring 12 with the first ring 10 and mounting the new row of rollers 22 between the first and second raceways 40, 38. The new row of rollers 22 is mounted by inserting the rollers 22 through the slot 31. The method may then include a step E5 of assembling the first part ring 13 with the second part ring 14.

Thanks to the above method, the initial rolling bearing 50 becomes the rolling bearing 11 by being adapted to rollers 22 while the coupling portion 24 remains mostly unmodified because of the relatively small extent of the slot 31. The coupling recess 17 of the first part ring 13 thus remains compatible with the coupling portion 24 of the second part ring 14 for ensuring the immobilizing function of the first part ring 13 with respect to the second part ring 14. The first part ring 13 can thus directly be reused to obtain the rolling bearing 11.

The method may include a step of determining the constant thickness of the layer of material 52 to be removed. For instance, the thickness of layer 52 may be determined such as to include, entirely or not, degraded parts of the raceway portion 26, that is parts including degraded material. Such degraded material may result from the loads exerted by the rollers 51 on the raceway 38 during a previous use of the rolling bearing 50.

In a variant, the diameter of rollers 22 may be first determined as a target predetermined diameter, for instance based on the value of a radial load the rolling bearing 11 will be submitted to when in use, the thickness of layer 52 being then determined based on the target predetermined diameter.

In a variant, the initial rolling bearing is a rolling bearing similar to the rolling bearing 11, the annular protrusion 27 being thus an initial annular protrusion and the at least one slot 31 being thus an at least one initial slot.

By applying the above-described method, a further layer of material, which was next to layer 52, is removed from the raceway 38. Accordingly, the new annular protrusion of the thus obtained rolling bearing includes the initial annular protrusion 27.

The initial slot 31 may be machined to become the new slot or the new protrusion may be machined to form another slot, distinct from the initial slot 31. In other words, the slot of the thus obtained rolling bearing may include the initial slot 31 or being distinct from the initial slot 31. Then another row of rollers having a diameter adapted to the new distance between raceways 38 and 40 may be provided.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved rolling bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A rolling bearing comprising:
a first ring having a radial raceway, and
a second ring configured to rotate concentrically relative to the first ring about an axis of rotation, the second ring comprising a first ring part and a second ring part joined together in an axial direction at a joint to form the second ring, and
a row of radial rolling elements radially interposed between the radial raceway of the first ring and a radial raceway of the second ring, the radial raceway of the second ring being formed on the second ring part,
wherein the first ring part includes an axially projecting circumferential flange,
wherein the second ring part includes an annular protrusion axially delimiting the radial raceway of the second ring and protruding radially toward the first ring,
wherein a circumferential surface of the flange is in contact with a circumferential surface of with the protrusion,
wherein the flange includes a slot extending axially through the flange, the slot being open toward the first ring, and
wherein the slot is dimensioned such that each radial rolling element can pass axially through the slot.

2. The rolling bearing according to claim 1,
wherein a radial distance from a radially bottom wall of the slot and the radial raceway of the first ring is at least equal to a diameter of each of the radial rolling elements, and
wherein a circumferential distance between opposite lateral walls of the slot is at least equal to the diameter of each radial rolling element.

3. The rolling bearing according to claim 2,
wherein the circumferential distance between the opposite lateral walls of the slot is two times the diameter of each radial rolling elements.

4. The rolling bearing according to claim 2,
wherein the radially bottom wall has a diameter equal to a diameter of the radial raceway of the second ring.

5. The rolling bearing according to claim 1, including:
a first row of axial rolling elements interposed axially between an axial raceway of the first ring part and a first axial raceway of the first ring, and
a second row of axial rolling elements interposed axially between an axial raceway of the second ring part and a second axial raceway of the first ring,
wherein the first and second rows of axial rolling elements form a axial thrust bearing and the radial rolling elements form a radial thrust bearing.

6. The rolling bearing according claim 1,
wherein the first ring is a radially outer ring and the second ring is a radially inner ring.

7. A method comprising:
providing a rolling bearing comprising:
a first ring having a radial raceway,
a second ring configured to rotate concentrically relative to the first ring about an axis of rotation, the second ring comprising a first ring part having an axially projecting circumferential flange and a second ring part joined together in an axial direction at a joint to form the second ring, and
a set of first radial rolling elements having a first diameter radially interposed between the radial raceway of the first ring and a radial raceway of the second ring, the radial raceway of the second ring being formed on the second ring part,
separating the second part ring from the first part ring and removing the row of first radial rolling elements,
removing an annular layer of material from the second raceway to form a modified second raceway and an annular protrusion axially delimiting the modified second raceway and protruding radially relative to the modified second raceway, and
forming a slot axially through the protrusion, the slot being open toward the first ring and having a radial depth and a circumferential width,
installing a set of second radially rolling elements having a second diameter different than the first diameter though the slot and to a location between the modified second raceway and the radial raceway of the first ring, the second diameter being equal to a sum of the first diameter and a radial thickness of the annular layer of material, and
reconnecting the second ring part to the first ring part.

8. The method according to claim 7,
wherein a radially facing circumferentially extending surface of the flange of the first ring part has a same diameter as a radially facing circumferentially extending surface of the annular protrusion.

9. The method according to claim 8,
wherein the rolling bearing includes a set of annular rolling elements between an axial raceway of the first ring part and an axial raceway of the first ring, and
wherein the method includes, after separating the second ring part from the first ring part, removing the set of annular rolling elements.
